(19) United States
(12) Patent Application Publication
(10) Pub. No.: US 2020/0254499 A1
(43) Pub. Date: Aug. 13, 2020

(54) BILLET SUPPLY DEVICE

(71) Applicant: Ube Machiney Comrporation, Ltd., Ube-shi (JP)

(72) Inventor: Takeharu Yamamoto, Ube-shi (JP)

(21) Appl. No.: 16/642,465

(22) PCT Filed: Dec. 13, 2018
(86) PCT No.: PCT/JP2018/045966

§ 371 Date: Feb. 27, 2020

(30) Foreign Application Priority Data
Dec. 19, 2017 (JP) 2017-242388

(51) Int. Cl. B21C 33/00; B21C 23/21

(52) U.S. Cl. CPC B21C 33/00; B23Q 7/043; B21C 23/212

(57) ABSTRACT

A billet supply device is provided with: a base; a first frame supported on the base to be freely movable back-and-forth; a first movement conversion mechanism for moving the first frame back-and-forth with respect to the base; a second frame provided with a billet mounting unit and supported on the first frame to be freely movable back-and-forth; and a second movement conversion mechanism for moving the second frame back-and-forth with respect to the first frame. Parts of both movement conversion mechanisms including a ball screw mechanism are supported rotatably on a common support member for the first frame. The first frame and the second frame are moved back and forth to the extrusion center side with respect to the base simultaneously by a driver for rotationally driving the parts at the same time.

### FIELD

The present invention relates to a billet supply system supplying a billet to a container of an extrusion press, more particularly relates to a billet supply system able to make a billet loader in which a billet is carried move in a direction perpendicular to an extrusion direction of the extrusion press to a position matching a center axis of a billet holding part of the container and insert the billet into the billet holding part.

### BACKGROUND

In general, if extruding a billet of a metal material, for example, a material of aluminum or its alloy, by an extrusion press, first, a new billet is inserted and held (upset operation) into a billet holding part of a container. Specifically, an extrusion stem attached through a main cross head to the front end part of a main ram which is housed in a main hydraulic cylinder and which is able to be driven in the extrusion direction is made to retract in an opposite direction to the extrusion direction. In a general configuration, the extrusion stem is retracted by a hydraulic actuator separate from the main hydraulic cylinder such as a side cylinder connected to the main cross head etc. After that, the billet supply system provided with the billet loader on which the billet is carried makes the billet loader move from a billet supply position outside of the extrusion press etc. in a direction perpendicular to the extrusion direction of the extrusion press to a position matching the center axis of the billet holding part of the container.

Then, in the state using the container cylinder etc. to press the container against the die, the billet carried on the billet loader is inserted and held (upset operation) in the billet holding part of the container by making the extrusion stem advance in the extrusion direction. Then, using the billet supply system, the billet loader of the system is made to retract from a position matching the center axis of the billet holding part of the container (extrusion center), then the main ram is made to advance further in the extrusion direction and the billet in the billet holding part is powerfully pressed by the extrusion stem whereby a shaped product is extruded from the exit part of the die designed matching the cross-sectional shape of the product.

In such a conventional type of extrusion press, when inserting a billet in a container, the extrusion stem must be made to retract in the opposite direction to the extrusion direction by the entire length of this billet or the billet loader on which the billet is carried. For this reason, the drive stroke of the main ram becomes a stroke required for making the extrusion stem be inserted (advance) into the billet holding part of the container and pushing the billet inside the billet holding part out from the exit part of the die (substantially equal to total length of extrusion stem) plus the total length of the billet or the billet loader. To secure the drive stroke of the main ram, the total length of the main hydraulic cylinder for driving the main ram becomes longer. Along with this, the total length of the extrusion press also becomes longer and greater installation space is required in the length direction of the extrusion press. Since the total length of the main hydraulic cylinder becomes longer, the amount of working fluid required for driving (advancing) the main ram also becomes greater. This invites an increase in the number of hydraulic pumps for this, an increase in the hydraulic pump capacity, or an increase in the drive time or consumed power of the electric motor for driving the hydraulic pump.

In recent years, in view of the above-mentioned problems, to reduce the space required for installation of the extrusion press and reduce the energy of the power consumed for driving the hydraulic pump, an extrusion press with a short total length keeping down the drive stroke of the main ram has been sought. An extrusion press called a “short stroke press type” has been developed for the purpose of keeping down the drive stroke of the main ram. In a short stroke press type extrusion press, a method different from the conventional billet supply method is adopted, so space for supply of a billet is not required or is shortened and the drive stroke of the main ram is kept down.

Short stroke press systems are divided into two types according to the position of supply of the billet to the container. One is the front loading type (for example, see Japanese Unexamined Patent Publication No. 63-132717). In this front loading type, at the time of supply of the billet, the container is moved to the extrusion stem side by a container cylinder etc. and space for supply of the billet is secured between the moved container and the die arranged at the extrusion stem side of the end platen (platen 11 of Japanese Unexamined Patent Publication No. 63-132717) (die 14 of Japanese Unexamined Patent Publication No. 63-132717). The billet is inserted in the container storage part by making the container moved to the extrusion stem side move again to the die side (end platen side) by the container cylinder etc.

On the other hand, the other is a back loading type shown in FIG. 1 and FIG. 2A to FIG. 2C. In this back loading type, at the time of supply of the billet, the extrusion stem is made to move from an initial extrusion stem position on the extrusion stem mounting surface of the main cross head to secure space for supply of the billet at the initial extrusion stem position.

FIG. 1 is a schematic plan view of an extrusion press in which the back loading type short stroke press system is employed. In this extrusion press, an end platen 1 and a cylinder mounting block 2 are connected and fixed by tie rods 3. A die 4 is attached to the end platen 1. A container 5 provided with a billet holding part C is pushed against the die 4 by a not shown container cylinder etc.

At the cylinder mounting block 2, the main hydraulic cylinder 8 for making the extrusion stem 6 move (advance/push) is attached. The main hydraulic cylinder 8 houses inside it a not shown main ram driven by hydraulic pressure in the extrusion direction. At the front end of the main ram, a main cross head 7 is attached. At this main cross head 7, the extrusion stem 6 is attached. If making the main ram of the main hydraulic cylinder 8 advance, the extrusion stem 6 can be made to move along the center axis of the billet holding part C of the container 5, that is, the extrusion center, and the billet inside the billet holding part can be powerfully pushed by the extrusion stem.

Next, while referring to FIG. 2A to FIG. 2C, the billet supply operation in the extrusion press of the back loading type shown in FIG. 1 will be explained. FIG. 2A to FIG. 2C, like FIG. 1, are schematic plan views. Configurations the same as the extrusion press of FIG. 1 are assigned the same notations.

First, the extrusion stem 6 shown in FIG. 2A is made to move to the left direction (upward in FIG. 2A) as seen from the end platen 1 side. Then, billet supply system moves the billet loader BL (in FIG. 2A to FIG. 2C, the billet loader) from the right direction when seen from the end platen 1 side (in FIG. 2A, the bottom/billet supply position) to the initial position of the extrusion stem 6 (position matching center axis of billet holding part C of container 5). Then, it drives the billet insertion mechanism BS provided at the billet loader BL (billet loader) to, as shown in FIG. 2B, insert the billet B carried on the billet loader BL into the billet holding part C of the container 5.

The billet loader BL provided with the billet insertion mechanism BS is a device for inserting a billet B moved to a position matching with the center axis of the billet holding part C of the container 5 into the billet holding part C of the container 5. In a conventional type of extrusion press where the billet B is inserted into the billet holding part C of the container 5 by the advancing operation of the extrusion stem 6 or the previously explained front loading type of extrusion press where the container itself is made to move to insert the billet inside the billet holding part of the container (Japanese Unexamined Patent Publication No. 63-132717), generally only a billet loader BL has been provided. A billet insertion mechanism BS has not been provided.

After the billet B finishes being inserted into the billet holding part C of the container 5, the billet loader BL, as shown in FIG. 2C, is made to move (retract) by a not shown billet supply system from the initial position of the extrusion stem 6 in the right direction seen from the end platen 1 side (in FIG. 2C, bottom/billet supply position). After this, the extrusion stem 6 which had been made to move in the left direction seen from the end platen 1 side (in FIG. 2A, upper) is made to move to the initial position of the extrusion stem 6 (position matching center axis of billet holding part C of container 5). After this, by making the not shown main ram housed in the main hydraulic cylinder 8 advance, the upset operation of the billet B to the billet holding part C of the container 5 (operation for inserting and holding billet at billet holding part C) is ended. Then, by making the not shown main ram further advance, the action of the extrusion stem 6 pressing against the billet B by is started, then the billet B is extruded from the die 4.

### SUMMARY

### Technical Problem

Here, in an extrusion press of the back loading type short stroke press system explained above, as shown in FIG. 3A and FIG. 3B, the billet loader BL has to be made to move to between the billet supply position and the position at which the extrusion stem was initially set (position matching center axis of billet holding part of the container C). FIG. 3A and FIG. 3B are views along the arrow A of FIG. 2A and show images of a conventional billet supply system 10 (schematic side view).

FIG. 3A shows the state where a billet B is carried on the billet loader BL at the billet supply position. As explained earlier, the extrusion stem 6 is moved by a not shown driving means along the extrusion stem guide means 6a in the left direction seen from the end platen 1 side.

The billet supply system 10 not illustrated in FIG. 1 and FIG. 2A to FIG. 2C will be explained next while referring to FIG. 3A and FIG. 3B. The billet supply system 10 is mainly comprised of a base 11 arranged separated from the extrusion center to enable placement of a billet B on the billet loader BL at the billet supply position shown in FIG. 3A and a main frame 12 guided and supported by the base 11 to be able to advance and retract with respect to the extrusion center side, and having the billet loader BL arranged at the extrusion center side end.

The billet supply position shown in FIG. 3A has to be a position enabling a new billet B to be placed on the billet loader BL from for example above in parallel to the billet holding part C of the container 5 without interfering with movement of the main cross head 7 at the time of an extrusion operation etc. and further not interfering with the tie rods 3 or other parts of the extrusion press or ancillary apparatuses. Here, the horizontal direction between the billet supply position and the extrusion center of the extrusion stem 6 of the extrusion press in FIG. 3A is designated as L1 (below, the “billet conveyance distance”) and the length of the part of the main frame 12 projecting from the base 11 to the outside of the extrusion press is designated as L2 (below, the “base rear projecting distance”).

Next, as shown in FIG. 3B, the billet loader BL is made to move to the initial position of the extrusion stem 6 (position matching center axis of billet holding part C of container 5) by making the main frame 12 advance. In FIG. 3A and FIG. 3B, the guidance and support structure of the main frame 12 with respect to the base 11 is made an up-down direction roller support structure easy to understand from the illustrations, but a support structure using a known linear guide comprised of a rail and a block guided to the rail or a known support structure other than that may also be employed. Illustration of the driving means for advancing movement of the main frame 12 to the extrusion center side and retracting movement to the billet supply position is omitted for simplifying the illustration, but a structure for driving rotation of rollers for supporting the main frame 12 by an electric motor etc., an embodiment driving the same by an actuator using pneumatic or hydraulic pressure as a drive source, or an embodiment driving the same by a combination of a ball-nut mechanism and electric motor or other suitable embodiment may also be suitably adopted.

However, the larger the extrusion press becomes, the heavier the weight of the billet B supplied to the container 5 and, further, the longer the billet conveyance distance L1 must become. For this reason, in the above such conventional billet supply system 10, to deal with the increase in weight of the billets handled and the increase in the billet conveyance distance L1, the rigidity of the main frame 12 itself must be raised. Due to this, the weight of the main frame 12 increases.

As a result, in billet changing work, it becomes difficult to make the billet loader BL move back and forth between the billet supply position shown in FIG. 3A and the position matching the center axis of the billet holding part C of container 5 shown in FIG. 3B at the desired speed and the productivity of the extrusion press is liable to fall.

On the other hand, to maintain or improve the productivity of the extrusion press, in billet changing work, in order to make the billet loader BL move back and forth between the billet supply position and the position matching the center axis of the billet holding part C at the desired speed, the output of the driving means for movement has to be made to increase corresponding to the main frame 12 increased in weight. For this reason, the driving means for making the main frame 12 move back and forth, in the case of such an actuator, has to be increased in supplied pneumatic pressure or supplied hydraulic pressure resulting in an increased cost. Even in the case of an electric motor, an increase in size of the motor is invited and the cost rises. In particular, if employing a servo motor for improving the precision of stopping at the billet supply position and at the position matching the center axis of the billet holding part C or improving the control of the speed of movement between the two, a further increase in cost is invited.

The present invention is made in consideration of the above such problem and has as its object the provision of a billet supply system making a billet loader move back and forth between a billet supply position and an extrusion center of an extrusion stem of an extrusion press, in which billet supply system it is possible to keep an output of a driving means making the billet loader move back and forth from increasing while making the billet loader move back and forth by a desired speed.

### Solution to Problem

The object of the present invention is achieved by a billet supply system having a billet loader carrying a billet in parallel with a billet holding part in a container of an extrusion press and making the billet loader move back and forth between a supply position of the billet and an extrusion center of an extrusion stem of the extrusion press, the billet supply system comprising

a base arranged separated from the extrusion center to enable placement of a billet on the billet loader at the supply position,

a first frame guided and supported by the base to be able to advance and retract with respect to the extrusion center side,

a first motion conversion mechanism including a first ball screw shaft and a first ball nut screwed with the first ball screw shaft and making the first frame advance and retract with respect to the base,

a second frame guided and supported by the first frame to be able to advance and retract with respect to the extrusion center side and at which the billet loader is arranged at the extrusion center side end,

a second motion conversion mechanism including a second ball screw shaft and a second ball nut screwed with the second ball screw shaft and making the second frame advance and retract with respect to the first frame,

a common support member fixed to the first frame on which either of the first ball screw shaft and the first ball nut and either of the second ball screw shaft and the second ball nut are rotatably supported, and

a driving means for simultaneously driving rotation of either of the first ball screw shaft and the first ball nut and either of the second ball screw shaft and the second ball nut rotatably supported by the common support member through a transmission member,

wherein the other of the first ball screw shaft and the first ball nut is fixed to the base to be unable to rotate,

the other of the second ball screw shaft and the second ball nut is fixed to the second frame to be unable to rotate, and

the driving means being used to make the first frame and the second frame simultaneously advance and retract with respect to the base to and from the extrusion center side.

In the billet supply system according to the present invention, a first rotation transmission member and a second rotation transmission member may be arranged at the rotating end parts of the first motion conversion mechanism and the second motion conversion mechanism at the sides rotatably supported by the common support member, and the first rotation transmission member and the second rotation transmission member may be configured to be able to directly transmit rotational motion of one to the other.

Furthermore, in the billet supply system according to the present invention,

the first ball nut of the first motion conversion mechanism may be rotatably supported by the common support member, and

the second ball screw shaft of the second motion conversion mechanism may be rotatably supported by the common support member.

On the other hand, the billet supply system according to the present invention may further comprise a billet insertion mechanism whereby the billet loader inserts the carried billet in the billet holding part of the container at the extrusion center.

### Advantageous Effects of Invention

The billet supply system according to the present invention is a billet supply system having a billet loader carrying a billet in parallel with a billet holding part in a container of an extrusion press and making the billet loader move back and forth between a supply position of the billet and an extrusion center of an extrusion stem of the extrusion press, the billet supply system comprising

a base arranged separated from the extrusion center to enable placement of a billet on the billet loader at the supply position,

a first frame guided and supported by the base to be able to advance and retract with respect to the extrusion center side,

a first motion conversion mechanism including a first ball screw shaft and a first ball nut screwed with the first ball screw shaft and making the first frame advance and retract with respect to the base,

a second frame guided and supported by the first frame to be able to advance and retract with respect to the extrusion center side and at which the billet loader is arranged at the extrusion center side end,

a second motion conversion mechanism including a second ball screw shaft and a second ball nut screwed with the second ball screw shaft and making the second frame advance and retract with respect to the first frame,

a common support member fixed to the first frame on which either of the first ball screw shaft and the first ball nut and either of the second ball screw shaft and the second ball nut are rotatably supported, and

a driving means for simultaneously driving rotation of either of the first ball screw shaft and the first ball nut and either of the second ball screw shaft and the second ball nut rotatably supported by the common support member through a transmission member,

wherein the other of the first ball screw shaft and the first ball nut is fixed to the base to be unable to rotate,

the other of the second ball screw shaft and the second ball nut is fixed to the second frame to be unable to rotate, and

the driving means being used to make the first frame and the second frame simultaneously advance and retract with respect to the base to and from the extrusion center side. Thus, it is possible to keep an output of a driving means making the billet loader move back and forth from increasing while making the billet loader move back and forth by a desired speed.

### BRIEF DESCRIPTION OF DRAWINGS

FIG. 1 is a schematic plan view explaining the configuration of a back loading type extrusion press.

FIG. 2A is a schematic plan view explaining the supply and insertion of a billet in the back loading type extrusion press shown in FIG. 1.

FIG. 2B is a schematic plan view explaining the supply and insertion of a billet in the back loading type extrusion press shown in FIG. 1.

FIG. 2C is a schematic plan view explaining the supply and insertion of a billet in the back loading type extrusion press shown in FIG. 1.

FIG. 3A is a view along the arrow A of FIG. 2A showing an image of a conventional billet supply system (schematic side view).

FIG. 3B is a view along the arrow A of FIG. 2A showing an image of a conventional billet supply system (schematic side view).

FIG. 4A is a view of an image of a billet supply system of the present invention for facilitating comparison of FIG. 3A and FIG. 3B (schematic side view).

FIG. 4B is a view of an image of a billet supply system of the present invention for facilitating comparison of FIG. 3A and FIG. 3B (schematic side view).

FIG. 5A is a schematic side view and view along the arrow B-B of a billet supply system according to the first embodiment.

FIG. 5B is a schematic side view and view along the arrow B-B of a billet supply system according to the first embodiment.

FIG. 5C is a schematic side view and view along the arrow B-B of a billet supply system according to the first embodiment.

FIG. 6 is a schematic side view (including a partial cross-sectional view) of a billet supply system according to a second embodiment.

FIG. 7 is a schematic side view (including a partial cross-sectional view) of a billet supply system according to a third embodiment.

FIG. 8A is a schematic side view (including a partial cross-sectional view) of a billet supply system according to a fourth embodiment and a modification of that embodiment.

FIG. 8B is a schematic side view (including partial cross-section) showing a billet supply system according to the fourth embodiment and a modification of that embodiment.

FIG. 9A is a schematic side view (including partial cross-section) showing a billet supply system according to a fifth embodiment and a modification of that embodiment.

FIG. 9B is a schematic side view (including partial cross-section) showing a billet supply system according to the fifth embodiment and a modification of that embodiment.

FIG. 10A is a view along the arrow C of FIG. 5A and back view showing another embodiment of the driving means and transmission member able to be employed for the embodiment.

FIG. 10B is a view along the arrow C of FIG. 5A and back view showing another embodiment of the driving means and transmission member able to be employed for the embodiment.

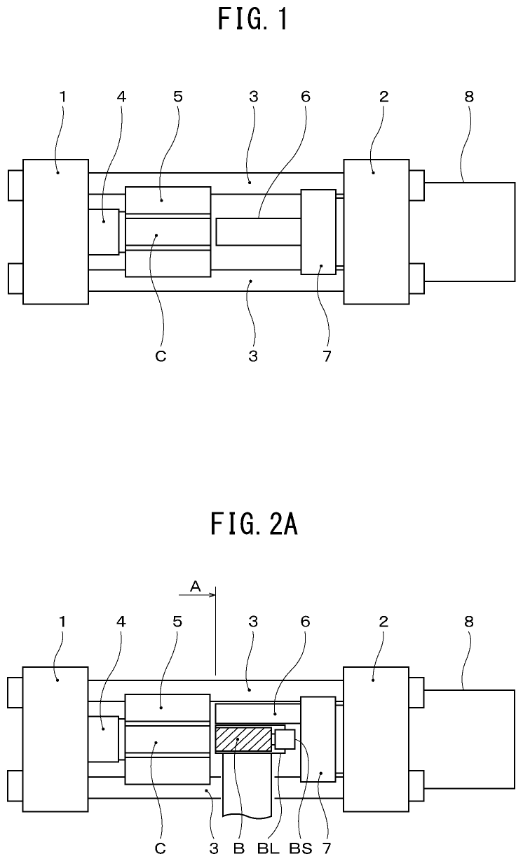

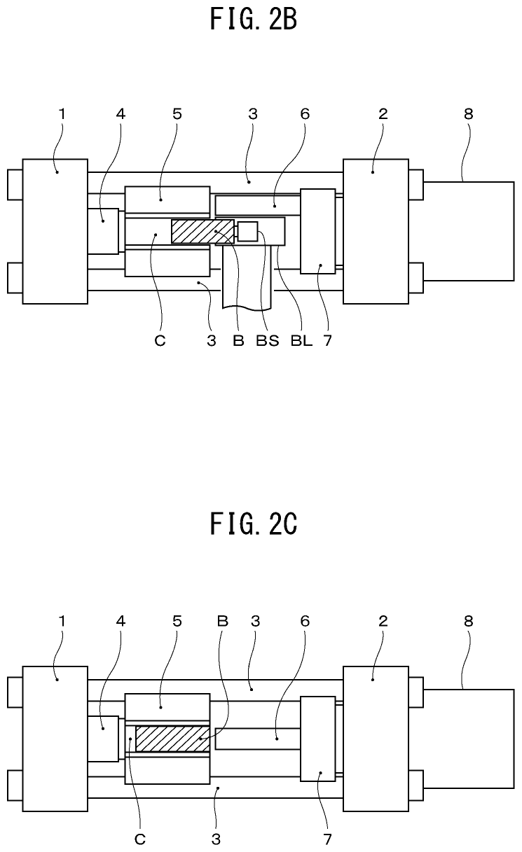

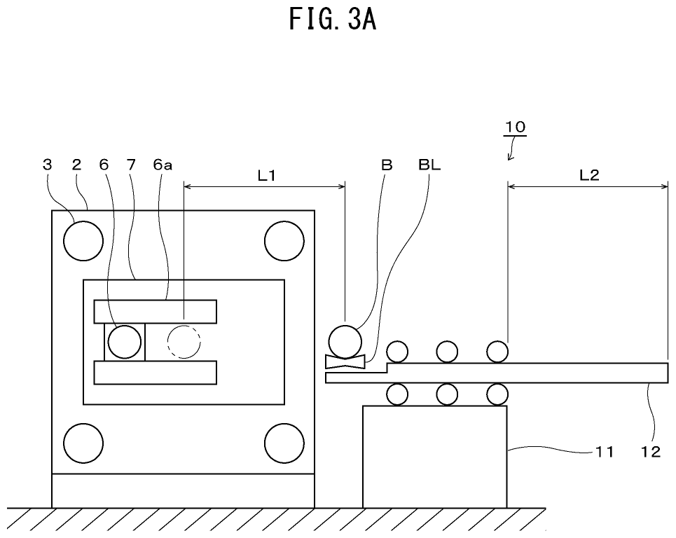

### DESCRIPTION OF EMBODIMENTS

Below, embodiments for working the present invention will be explained in detail while referring to the attached drawings. Note that, the following embodiments do not limit the inventions according to the claims. Further, not all of the combinations of the features explained in the embodiments are essential for solution of the invention.

### First Embodiment

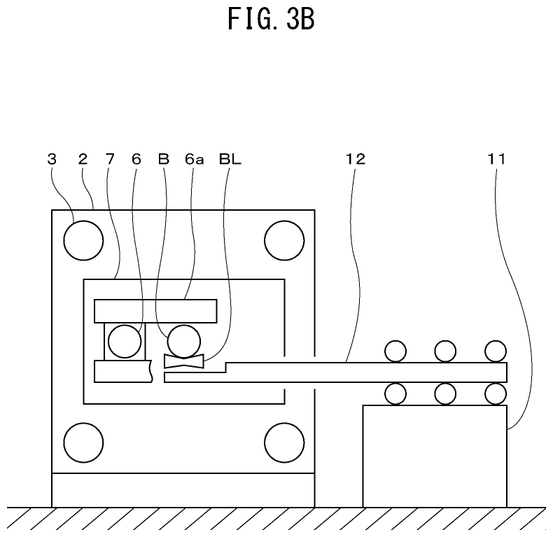

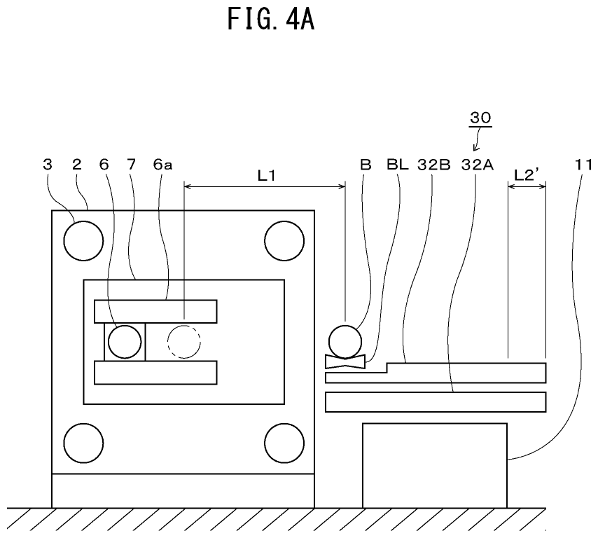

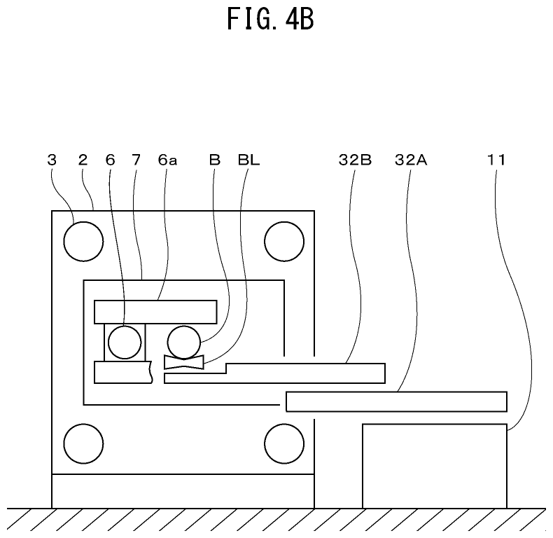

Before explaining the first embodiment, first, the billet supply system according to the present invention will be explained while referring to FIG. 4A and FIG. 4B. FIG. 4A and FIG. 4B show images of the billet supply system of the present invention for facilitating comparison of FIG. 3A and FIG. 3B (schematic side views). Configurations the same as or functionally no different from FIG. 3A and FIG. 3B will be assigned the same notations as in FIG. 3A and FIG. 3B.

The billet supply system 30 is provided with

a base 11 arranged separated from the extrusion center to enable placement of a billet B on the billet loader BL at the supply position shown in FIG. 4A,

a first frame 32A guided and supported by the base 11 to be able to advance and retract with respect to the extrusion center side, and

a second frame 32B guided and supported by the first frame 32A to be able to advance and retract with respect to the extrusion center side and at which the billet loader BL is arranged at the extrusion center side end.

The billet conveyance distance between the billet supply position shown in FIG. 4A and the extrusion center of the extrusion stem 6 of the extrusion press is L1 in the same way as FIG. 3A. On the other hand, the base rear projecting distance is L2′ where L2>L2′.

The billet supply system 30, while not illustrated in FIG. 4A and FIG. 4B, is provided with a first motion conversion mechanism 34 including a ball-nut mechanism and making the first frame 32A advance and retract with respect to the base 11, a second motion conversion mechanism 36 including a same ball-nut mechanism and making the second frame 32B advance and retract with respect to the first frame 32A, and a common support member 37 fixed to the second frame 32B and on which either of the first ball screw shaft 34A and the first ball nut 34B of the first motion conversion mechanism 34 and either of the second ball screw shaft 36A and second ball nut 36B of the second motion conversion mechanism 36 are rotatably supported.

The billet supply system 30 is further provided with a driving means 38 for simultaneously driving rotation of either of the first ball screw shaft 34A and the first ball nut 34B and either of the second ball screw shaft 36A and the second ball nut 36B rotatably supported by the common support member 37 through the transmission member.

In the billet supply system 30 according to the present invention, based on the above-mentioned configuration, the other of the first ball screw shaft 34A and the first ball nut 34B is fixed to the base 11 to be unable to rotate while the other of the second ball screw shaft 36A and the second ball nut 36B is fixed to the second frame 32B to be unable to rotate. Due to the driving means 38, the first frame 32A and the second frame 32B can be made to simultaneously advance and retract with respect to the base 11 to and from the extrusion center side.

That is, the main frame 12 of FIG. 3A and FIG. 3B making the billet loader BL move is divided into two. The rotationally driven objects (ball screw shafts or ball nuts) of the motion conversion mechanisms comprised of the ball-nut mechanisms for making the frames move are rotatably supported by the common support member 37 fixed to the first frame 32A moving with respect to the base 11. By using the driving means 38 to simultaneously drive rotation of these rotationally drive objects, the first frame 32A moves with respect to the base 11 and the second frame 32B moves with respect to the moving first frame 32A. As a result, the speed of movement of the billet loader BL becomes the total speed of the speed of movement of the first frame 32A with respect to the base 11 and the speed of movement of the second frame 32B with respect to the first frame 32A, so it is possible to keep the output of the driving means from increasing while greatly increasing the speed of movement of the billet loader BL and becomes easy to make them move at the desired speeds.

FIG. 4B shows the state of making the billet loader BL move with respect to the base 11 to the extrusion center side to the initial position of the extrusion stem 6 in this way. In the above-mentioned configuration, the rotationally driven objects of the first motion conversion mechanism 34 and the second motion conversion mechanism 36 rotatably supported by the common support member 37 fixed to the first frame 32A can be configured in various ways as either ball screw shafts or ball nuts. These configurations will be explained in a little more detail in the later explained embodiments. First, the first embodiment will be explained.

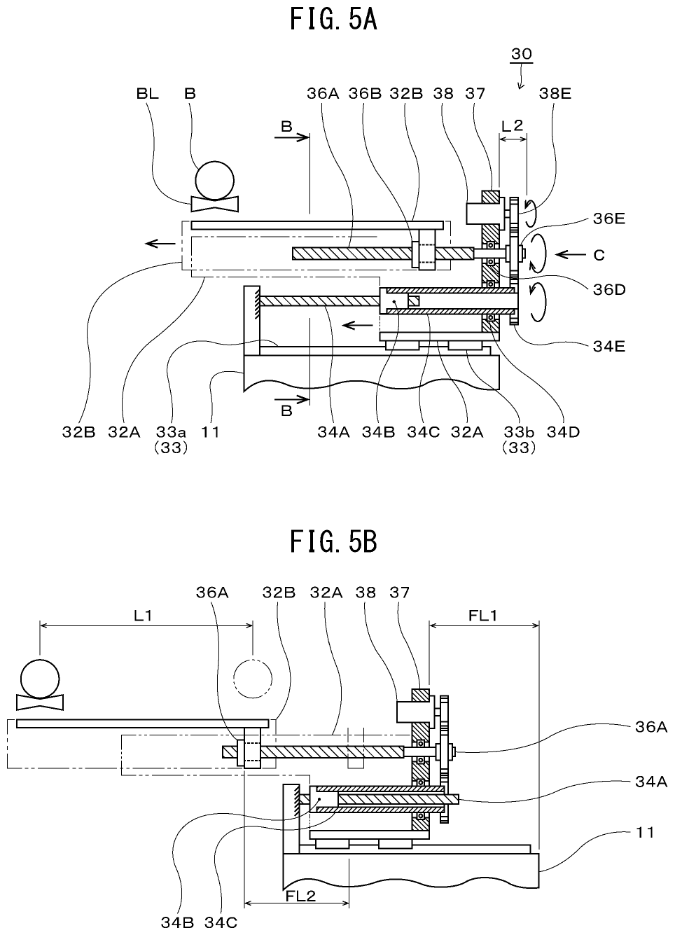

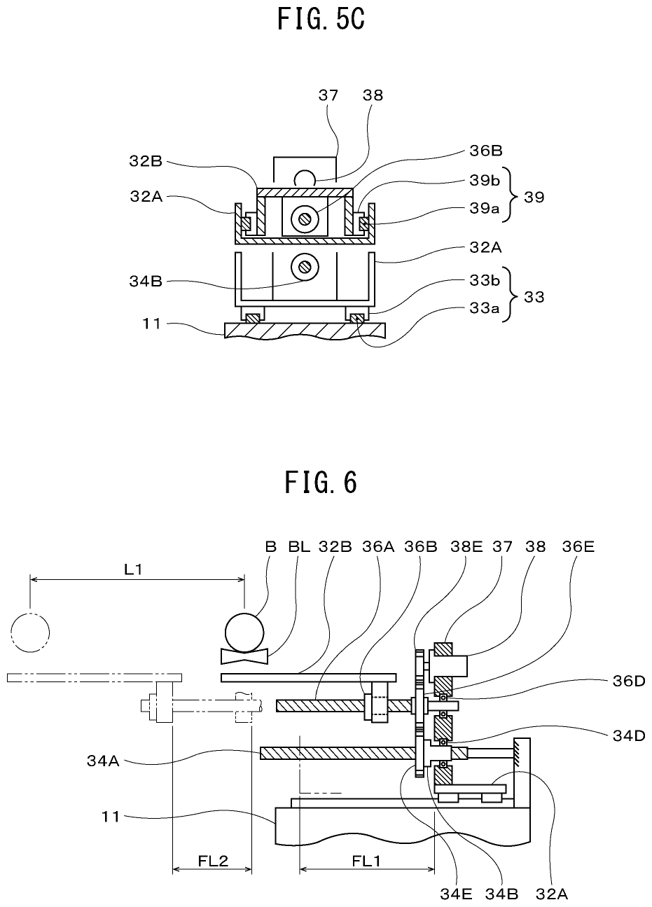

FIG. 5A to FIG. 5C are schematic side views of the billet supply system 30 according to the first embodiment and views along the arrow B-B (including partial cross-sectional view). FIG. 5A shows the state where the billet loader BL is at the billet supply position, while FIG. 5B shows the state where the first frame 32A and the second frame 32B are made to move (advance) with respect to the base 11 to the extrusion center side and the billet loader BL is moved (advanced) to the extrusion center position. FIG. 5C is a view along the arrow B-B of FIG. 5A for showing one example of the guidance and support configuration of the first frame 32A with respect to the base 11. The notation C of FIG. 5A shows an arrow view for the back view showing another embodiment relating to the driving means and transmission member able to be employed in the embodiments, so is not directly related to the explanation of the first embodiment.

As shown in FIG. 5A and FIG. 5C, the first frame 32A is guided by the linear guide 33 comprised of a rail 33a and a block 33b guided by the rail 33a and supported at the base 11. The rail 33a is fixed to the base 11 while the block 33b is fixed to the first frame 32A. Preferably, as shown in FIG. 5C, considering the support load and moment, a plurality of linear guides 33 may be arranged.

Behind the first frame 32A, the common support member 37 is fixed to stand upright. Below the common support member 37, the first ball nut 34B of the first motion conversion mechanism 34 is rotatably supported through the hollow member 34C and the first rotation support member 34D. One end of the first ball screw shaft 34A combined with the first ball nut 34B is fastened at the front of the base 11 to be unable to rotate. The hollow member 34C projects out to the rear from the common support member 37. At the projecting end, a first transmission member 34E able to transmit rotational force is fixed. In the first embodiment, the first transmission member 34E is made a spur gear.

Due to such a configuration, by transmitting rotational motion to the first transmission member 34E, the first frame 32A can be made to move (advance) in a desired direction with respect to the base 11 by the speed determined by the speed of rotation and direction of rotation of the first transmission member 34E and the lead and thread-cutting (right thread/left thread) specifications of the first motion conversion mechanism 34 (direction of movement of the ball screw shaft and ball nut in the relative axial direction relative to one turn of the ball screw shaft and ball nut). The first frame 32A may of course but configured by not only the solid line part to which the block 33b of the linear guide 33 is fixed, but also a shape enabling guidance and support of the second frame 32B as shown by the two-dot chain line.

Next, as shown in FIG. 5A and FIG. 5C, the second frame 32B is also guided and supported at the first frame 32A by a linear guide 39 comprised of a rail 39a and a block 39b guided by the rail 39a. The rail 39a is fastened to the first frame 32A while the block 39b is fastened to the second frame 32B.

Above the hollow member 34C rotatably supported by the common support member 37, the second ball screw shaft 36A of the second motion conversion mechanism 36 is rotatably supported through the second rotation support member 36D and the second ball nut 36B combined with the second ball screw shaft 36A is fixed to the second frame 32B (ball nut holding part) to be unable to rotate. The second ball screw shaft 36A projects to the rear from the common support member 37. At the projecting side end, a second transmission member 36E is fixed to be able to transmit rotational force. In the first embodiment, the second transmission member 36E is configured as a spur gear. The second transmission member 36E and the first transmission member 34E fixed to the end of the hollow member 34C of the first motion conversion mechanism 34 at the side projecting from the common support member 37 to the rear are configured to be able to directly transmit the rotational motion of one to the other.

In the same way as the first frame 32A, the second frame 32B is needless to say configured to correspond to the guidance and support shape of the first frame 32A not only by the solid line part where the billet loader BL is fixed and the second ball nut 36B is fixed to the ball nut holder to be unable to rotate but also as shown by the two-dot chain line.

Due to such a configuration, by transmitting rotational motion to the second transmission member 36E, the second frame 32B is made to move (advance) with respect to the first frame 32A at a speed determined by the speed of rotation and direction of rotation of the second transmission member 36E and the lead and thread-cutting (right thread/left thread) specifications of the second motion conversion mechanism 36.

The first transmission member 34E of the projecting end of the first motion conversion mechanism 34 and the second transmission member 36E of the projecting end of the second motion conversion mechanism 36 are configured to enable direct transmission of the rotational motion of one to the other, so, as shown in FIG. 5A, if rotational motion is transmitted to the second transmission member 36E of the projecting end of the second motion conversion mechanism 36 by an electric motor or other driving means 38 which is arranged above the second ball screw shaft 36A of the common support member 37 and which has a third transmission member 38E (in this case, a spur gear) attached to its output shaft, this rotational motion is also simultaneously transmitted to the first transmission member 34E of the projecting end of the first motion conversion mechanism 34, the first ball nut 34B of the first motion conversion mechanism 34 and the second ball screw shaft 36A of the second motion conversion mechanism 36 are simultaneously driven to rotate, and, as shown in FIG. 5B, the first frame 32A and the second frame 32B can be made to simultaneously move (advance) with respect to the base 11 to the extrusion center side.

As a result, the speed of movement of the billet loader BL becomes the total speed of the speed of movement of the first frame 32A with respect to the base 11 and the speed of movement of the second frame 32B with respect to the first frame 32A, so it is possible to keep the output of the driving means from increasing while greatly increasing the speed of movement of the billet loader BL and becomes easy to make it move by the desired speed. Further, as shown in FIG. 5B, the billet conveyance distance L1 becomes the total value of the distance FL1 of movement (advance) of the first frame 32A with respect to the base 11 and the distance FL2 of movement (advance) of the second frame 32B with respect to the first frame 32A, that is, the relationship L1=FL1+FL2 stands. FL1 and FL2 may be the same or different, but it is easier to make the distance FL1 of movement (advance) of the first frame 32A with respect to the base 11, where precision of guidance and support and rigidity are easily obtained, longer.

Therefore, it is sufficient that FL1 and FL2 be determined for the required billet conveyance distance L1 while considering the situation at the position of installation of the billet supply system 30 (other related apparatuses, moving parts of the apparatuses, ground piping and wiring, etc.) The speeds of rotation and directions of rotation of the first transmission member 34E and the second transmission member 36E and the leads and thread-cutting (right thread/left thread) of the first motion conversion mechanism 34 and the second motion conversion mechanism 36 should be suitably selected for making the billet loader BL move by the desired speed and in the desired direction. In FIG. 5A to FIG. 5C referred to in the explanation of the first embodiment and in FIG. 6 to FIG. 9A and FIG. 9B referred to in the explanation of the following embodiments, the first ball screw shaft 34A of the first motion conversion mechanism 34 and the second ball screw shaft 36A of the second motion conversion mechanism 36 are shown with hatching. The hatchings show the present configuration is a ball screw shaft. The inclinations of the hatching do not show the thread-cutting of the ball screw shaft (right thread/left thread).

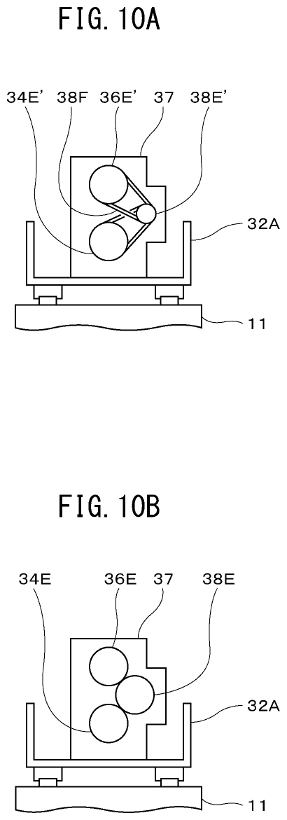

In the first embodiment, as shown in FIG. 5A to FIG. 5C, the first transmission member 34E of the first motion conversion mechanism 34 and the second transmission member 36E of the second motion conversion mechanism 36 are configured to be able to directly transmit the rotational motion of one to the other. The driving means 38 is used to transmit the rotational motion to the second transmission member 36E of the second motion conversion mechanism 36. However, the present invention can also be realized by using the driving means 38 to simultaneously drive rotation of the rotationally driven objects of the first motion conversion mechanism 34 and the second motion conversion mechanism 36 rotatably supported by the common support member 37. For this reason, the form of transmission of rotational motion of the driving means 38 such as shown in FIG. 10A and FIG. 10B, which are views along the arrow C of FIG. 5A, can also be employed.

FIG. 10A and FIG. 10B are views along the arrow C of FIG. 5A and back views showing modifications relating to the driving means and transmission members able to be employed in the later explained embodiments including the first embodiment. FIG. 10A employs a combination of pulleys and pulley belts as the transmission members rather than spur gears. Instead of the first transmission member 34E of the first motion conversion mechanism 34, the second transmission member 36E of the second motion conversion mechanism 36, and the third transmission member 38E of the driving means 38, pulleys 34E′, 36E′, and 38E′ are employed. These are connected by the pulley belts 38F.

In FIG. 10B, the transmission members are spur gears, but the first transmission member 34E of the first motion conversion mechanism 34 and the second transmission member 36E of the second motion conversion mechanism 36 are not configured to enable the rotational motion of one to be directly transmitted to the other. However, as shown in FIG. 10B, the third transmission member 38E of the driving means 38 is configured to be able to simultaneously transmit rotational motion to the first transmission member 34E of the first motion conversion mechanism 34 and the second transmission member 36E of the second motion conversion mechanism 36. The form of transmission of rotational motion of the driving means 38 such as shown in FIG. 10A and FIG. 10B increases the degree of freedom of setting the speeds of rotation of the first transmission member 34E and the second transmission member 36E and the arrangement of the driving means 38 from the first embodiment.

While not shown, the first transmission member 34E and the second transmission member 36E do not necessarily have to be spur gears. Suitable gears can be used. The output shaft of the driving means 38 does not necessarily have to be arranged in parallel with the directions of the rotational axes of these transmission members. The arrangement of the driving means 38 and transmission means may also be selected so that the output shaft of the driving means 38 perpendicularly intersects the rotational axis directions of these transmission members. The common support member 37 is made to be fixed to the first frame 32A, but the common support member 37 and the first frame 32A may also be configured by an integral structure. Part of the first frame 32A may also have the function of the common support member 37 in another configuration. In addition, in the first embodiment, a single driving means 38 is used to simultaneously drive rotation of the rotationally driven objects of the first motion conversion mechanism 34 and the second motion conversion mechanism 36 rotatably supported by the common support member 37, but while not shown, two or more driving means 38 may also be used so long as being able to simultaneously drive rotation of the rotationally driven objects.

On the other hand, in the first embodiment, as shown in FIG. 5A, the effect is also exhibited that the length of the part of the billet supply system 30 projecting from the base 11 to the outside of the extrusion press at the billet supply position, that is, the base rear projecting distance L2, can be greatly decreased compared with a conventional billet supply system 10 such as shown in FIG. 3A and FIG. 3B (embodiment employing main frame 12 of integral form where frame is not divided). When making the billet loader BL move (advance) from the billet supply position to the extrusion center, the ball screw shaft of the ball-nut mechanism never projects to the rear. Such a first embodiment is suitable for the case where there are restrictions on the space for installation of the billet supply system (in particular, the space at the rear of the base) with respect to the billet conveyance distance L1.

### Second Embodiment

Next, while referring to FIG. 6, a second embodiment will be explained. The second embodiment changes part of the first embodiment to another form. Specifically, as shown in FIG. 6, this mainly differs from the first embodiment on the point of fixing one end of the first ball screw shaft 34A of the lower first motion conversion mechanism 34 not at the front of the base 11 but the rear to be unable to rotate. The upper second motion conversion mechanism 36 is similar to that in the first embodiment (FIG. 5A to FIG. 5C). Along with this point of difference, in the first motion conversion mechanism 34, the hollow member 34C is not employed. The first ball nut 34B is directly supported through the first rotation support member 34D by the common support member 37 to be able to rotate. To keep down the lengths of the threaded parts of the first ball screw shaft 34A of the first motion conversion mechanism 34 and the second ball screw shaft 36A of the second motion conversion mechanism 36, the common support member 37 is fixed so as to stand not at the rear, but at the front of the first frame 32A and the first transmission member 34E, the second transmission member 36E, and third transmission member 38E are arranged not at the rear, but at the front of the common support member 37. In FIG. 6, configurations the same as or functionally no different from the first embodiment (FIG. 5A to FIG. 5C) will be assigned the same notations as in the first embodiment (FIG. 5A to FIG. 5C). To facilitate viewing of the drawings, illustration of the two-dot chain line showing the first frame 32A and the second frame 32B are omitted.

As shown in FIG. 6, in the second embodiment as well, to facilitate comparison with the first embodiment, the billet conveyance distance L1 is made the same length as the first embodiment (FIG. 5A to FIG. 5C). However, due to the previously explained difference, the relationship of L1=FL1+FL2 is made to stand while making the distance FL1 of movement (advance) of the first frame 32A with respect to the base 11 longer than the first embodiment and making the distance FL2 of movement (advance) of the second frame 32B with respect to the first frame 32A shorter by that amount.

In the second embodiment as well, it is sufficient that FL1 and FL2 be determined for the required billet conveyance distance L1 while considering the situation at the position of installation of the billet supply system 30 (other related apparatuses, moving parts of the apparatuses, ground piping and wiring, etc.) By the speeds of rotation and directions of rotation of the first transmission member 34E and the second transmission member 36E and the lead and thread-cutting (right thread/left thread) of the first motion conversion mechanism 34 and the second motion conversion mechanism 36 being suitably selected, it is possible to greatly increase the speed of movement of the billet loader BL and possible to keep the output of the driving means from increasing while making the billet loader BL move at a desired speed.

As shown in FIG. 6, it is possible to obtain the effect of making it possible to greatly reduce the base rear projecting distance L2 at the billet supply position compared with a conventional billet supply system 10. In the same way as the first embodiment, the second embodiment as well is suitable for the case where there are restrictions on the space at the rear of the base of the billet supply system with respect to the billet conveyance distance L1.

### Third Embodiment

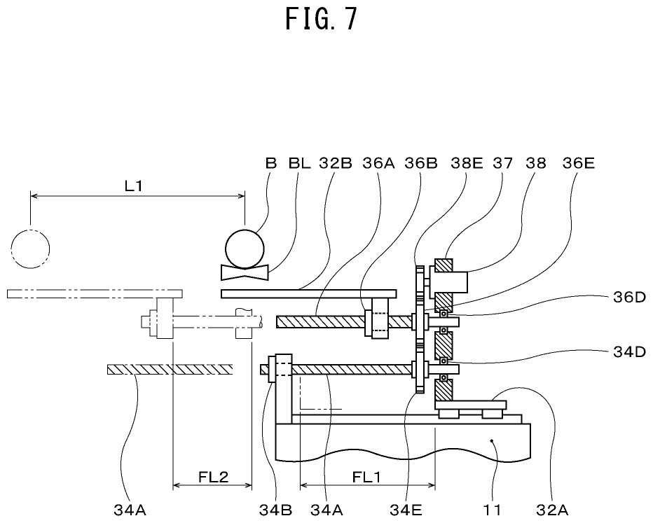

Next, while referring to FIG. 7, a third embodiment will be explained. The third embodiment, as shown in FIG. 7, mainly differs from the first embodiment and the second embodiment on the point that not the first ball nut 34B of the lower first motion conversion mechanism 34, but the first ball screw shaft 34A is rotatably supported through the first rotation support member 34D by the common support member 37. Due to this point of difference, the first ball nut 34B of the first motion conversion mechanism 34 is fixed at the front of the base 11 to be unable to rotate. On the other hand, the second ball screw shaft 36A of the upper second motion conversion mechanism 36 is rotatably supported through the second rotation support member 36D by the common support member 37 in the same way as the first embodiment (FIG. 5A to FIG. 5C) and the second embodiment (FIG. 6). Further, the common support member 37 is similar to the second embodiment on the point that it is fixed so as to project up not only at the rear of the first frame 32A but also the front and the first transmission member 34E, the second transmission member 36E, and third transmission member 38E are arranged not at the rear, but at the front of the common support member 37. In FIG. 7 as well, configurations the same as or functionally no different from the first embodiment (FIG. 5A to FIG. 5C) will be assigned the same notations as in the first embodiment (FIG. 5A to FIG. 5C). To facilitate viewing of the drawings, illustration of the two-dot chain line showing the first frame 32A and the second frame 32B are omitted.

As shown in FIG. 7, in the third embodiment as well, to facilitate comparison of the first embodiment and the second embodiment, the billet conveyance distance L1 is made the same length as the first embodiment (FIG. 5A to FIG. 5C). However, in the same way as the second embodiment, this establishes the relationship of L1=FL1+FL2 while making the distance FL1 of movement (advance) of the first frame 32A with respect to the base 11 longer than the first embodiment and making the distance FL2 of movement (advance) of the second frame 32B with respect to the first frame 32A shorter by that amount.

In the third embodiment as well, FL1 and FL2 may be determined for the required billet conveyance distance L1 while considering the situation at the position of installation of the billet supply system 30 (other related apparatuses, moving parts of the apparatuses, ground piping and wiring, etc.) By the speeds of rotation and directions of rotation of the first transmission member 34E and the second transmission member 36E and the leads and thread-cutting (right thread/left thread) of the first motion conversion mechanism 34 and the second motion conversion mechanism 36 being suitably selected, it is possible to keep the output of the driving means from increasing while making the billet loader BL move at the desired speed.

As shown in FIG. 7, the effect can be obtained that it is possible to greatly decrease the base rear projecting distance L2 at the billet supply position compared with the conventional billet supply system 10. In the same way as the first embodiment (FIG. 5A to FIG. 5C) and the second embodiment (FIG. 6), the third embodiment as well is preferable when there are restrictions on the space for installing the billet supply system (in particular, the space behind the base) with respect to the billet conveyance distance L1.

On the other hand, in the third embodiment, when making the billet loader BL move (advance) from the billet supply position to the extrusion center, as shown in FIG. 7, the first ball screw shaft 34A of the first motion conversion mechanism 34 operates to project to the front (extrusion center side). The amount by which the first ball screw shaft 34A projects to the front does not exceed the front end position of the second frame 32B, so if employing the third embodiment, it is sufficient to consider an operation making the first ball screw shaft 34A of the first motion conversion mechanism 34 project to the front (extrusion center side) together with the second frame 32B including the billet loader BL and other moving parts.

### Fourth Embodiment

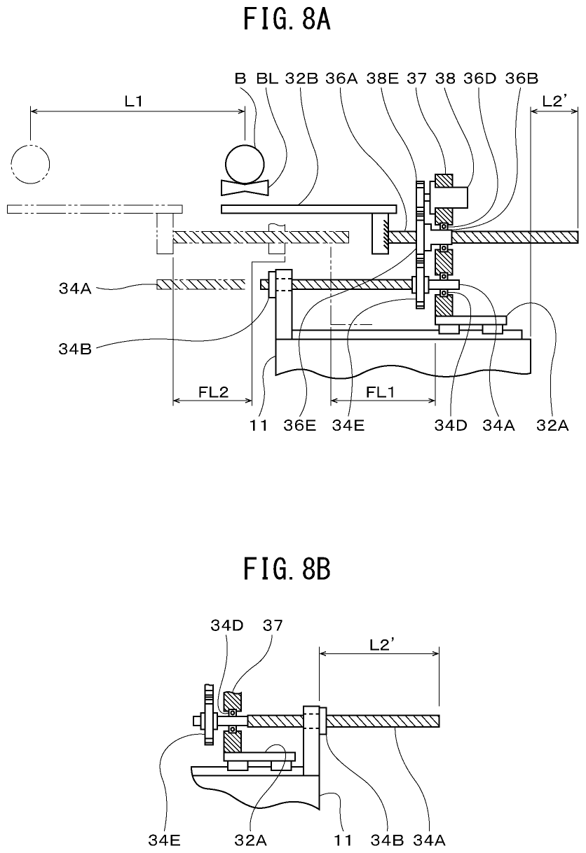

Next, referring to FIG. 8A and FIG. 8B, a fourth embodiment will be explained. FIG. 8A is a schematic side view (including partial cross-section) of the billet supply system 30 according to the fourth embodiment. FIG. 8B is a schematic side view (including partial cross-section) of the billet supply system 30 according to the fourth embodiment. The fourth embodiment differs from the first embodiment (FIG. 5A to FIG. 5C) and the second embodiment (FIG. 6) mainly on the point that the rotationally driven objects supported by the common support member 37 of the first motion conversion mechanism 34 and the second motion conversion mechanism 36 to be able to rotate are completely opposite from what is shown in FIG. 8A and FIG. 8B. That is, in the lower first motion conversion mechanism 34, not the first ball nut 34B, but the first ball screw shaft 34A is rotatably supported through the first rotation support member 34D by the common support member 37, while in the upper second motion conversion mechanism 36, not the second ball screw shaft 36A, but the second ball nut 36B is rotatably supported through the second rotation support member 36D by the common support member 37. Therefore, the lower first motion conversion mechanism 34 is similar to the third embodiment (FIG. 7), but the upper second motion conversion mechanism 36 differs from both the first embodiment to third embodiment, so only the second motion conversion mechanism 36 will be explained. In FIG. 8A and FIG. 8B as well, configurations the same as or functionally no different from the first embodiment (FIG. 5A to FIG. 5C) will be assigned the same notations as in the first embodiment (FIG. 5A to FIG. 5C). To facilitate viewing of the drawings, illustration of the two-dot chain line showing the first frame 32A and the second frame 32B are omitted.

As shown in FIG. 8A, above the first ball screw shaft 34A of the first motion conversion mechanism 34 rotatably supported by the common support member 37, the second ball nut 36B of the second motion conversion mechanism 36 is rotatably supported through the second rotation support member 36D while the second ball screw shaft 36A combined with the second ball nut 36B is fixed to the second frame 32B (ball screw shaft fixing part) to be unable to rotate.

In the fourth embodiment (FIG. 8A) as well, to facilitate comparison with the first embodiment and other embodiments, the billet conveyance distance L1 is made the same length of the first embodiment (FIG. 5A to FIG. 5C). The fourth embodiment establishes the relationship of L1=FL1+FL2 close to the first embodiment while making the distance FL1 of movement (advance) of the first frame 32A with respect to the base 11 about the same as the distance FL2 of movement (advance) of the second frame 32B with respect to the first frame 32A.

In the fourth embodiment as well, FL1 and FL2 may be determined for the required billet conveyance distance L1 while considering the situation at the position of installation of the billet supply system 30 (other related apparatuses, moving parts of the apparatuses, ground piping and wiring, etc.) Further, by the speeds of rotation and directions of rotation of the first transmission member 34E and the second transmission member 36E and the leads and thread-cutting (right thread/left thread) of the first motion conversion mechanism 34 and the second motion conversion mechanism 36 being suitably selected, it is possible to greatly increase the speed of movement of the billet loader BL and possible to keep the output of the driving means from increasing while making the billet loader BL move at the desired speed.

On the other hand, as shown in FIG. 8A, in the fourth embodiment, due to the configuration of the upper second motion conversion mechanism 36, at the billet supply position, the second ball screw shaft 36A of the second motion conversion mechanism 36 projects to the rear from the base 11 (base rear projecting distance L2′). In the fourth embodiment, the first ball nut 34B of the lower first motion conversion mechanism 34 combined with the first ball screw shaft 34A, like in the third embodiment (FIG. 7), is fixed to the front of the base 11 to be unable to rotate. As opposed to this, in the case of a modification (FIG. 8B) where the first ball nut 34B of the first motion conversion mechanism 34 combined with the first ball screw shaft 34A, like in the fourth embodiment, is fixed not to the front but to the rear of the base 11 to be unable to rotate, the first ball screw shaft 34A of the lower first motion conversion mechanism 34 projects to the rear from the base 11 more than the second ball screw shaft 36A of the second motion conversion mechanism 36 in the billet supply position (base rear projecting distance L2′).

In the fourth embodiment, as shown in FIG. 8A, in the same way as the third embodiment (FIG. 7), when making the billet loader BL move (advance) from the billet supply position to the extrusion center, the first ball screw shaft 34A of the first motion conversion mechanism 34 projects to the front (extrusion center side). The amount by which the first ball screw shaft 34A projects to the front does not exceed the front end position of the second frame 32B.

Considering these, if employing the fourth embodiment, it is sufficient to consider, together with the restrictions on space at the rear of the base of the billet supply system and the second frame 32B including the billet loader BL and other moving parts, the operation of making the shaft project to the front (extrusion center side) of the first ball-screw shaft 34A of the first motion conversion mechanism 34.

### Fifth Embodiment

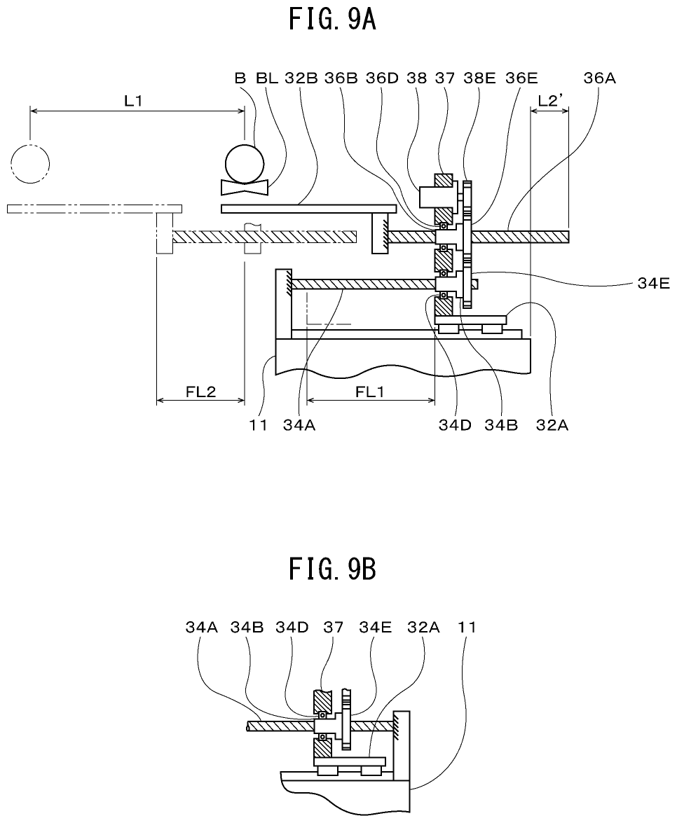

Next, referring to FIG. 9A and FIG. 9B, a fifth embodiment will be explained. FIG. 9A is a schematic side view (including partial cross-section) of the billet supply system 30 according to the fifth embodiment. FIG. 9B is a schematic side view (including partial cross-section) of the billet supply system 30 according to the fifth embodiment. The fifth embodiment differs from the third embodiment (FIG. 7) mainly on the point that the rotationally driven objects supported by the common support member 37 of the first motion conversion mechanism 34 and the second motion conversion mechanism 36 to be able to rotate (both ball screw shafts) are completely opposite from what is shown in FIG. 9A (both ball nuts). That is, in the lower first motion conversion mechanism 34, not the first ball screw shaft 34A, but the first ball nut 34B is supported through the first rotation support member 34D by the common support member 37 to be able to rotate, while in the upper second motion conversion mechanism 36, not the second ball screw shaft 36A, but the second ball nut 36B is supported through the second rotation support member 36D by the common support member 37 to be able to rotate. The configurations of these first motion conversion mechanism 34 and second motion conversion mechanism 36 are already explained in the embodiments up to now, so detailed explanations will be omitted. In FIG. 9A and FIG. 9B as well, configurations the same as or functionally no different from the first embodiment (FIG. 5A to FIG. 5C) will be assigned the same notations as in the first embodiment (FIG. 5A to FIG. 5C). To facilitate viewing of the drawings, illustration of the two-dot chain line showing the first frame 32A and the second frame 32B are omitted.

In the fifth embodiment (FIG. 9A) as well, to facilitate comparison with the first embodiment and other embodiments, the billet conveyance distance L1 is made the same length as the first embodiment (FIG. 5A to FIG. 5C). The fifth embodiment establishes the relationship of L1=FL1+FL2 close to the second embodiment and third embodiment while making the distance FL1 of movement (advance) of the first frame 32A with respect to the base 11 slightly longer than the distance FL2 of movement (advance) of the second frame 32B with respect to the first frame 32A.

In the fifth embodiment as well, FL1 and FL2 may be determined for the required billet conveyance distance L1 while considering the situation at the position of installation of the billet supply system 30 (other related apparatuses, moving parts of the apparatuses, ground piping and wiring, etc.) Further, by the speeds of rotation and directions of rotation of the first transmission member 34E and the second transmission member 36E and thread-cutting (right thread/left thread) and leads of the first motion conversion mechanism 34 and the second motion conversion mechanism 36 being suitably selected, it is possible to greatly increase the speed of movement of the billet loader BL and possible to keep the output of the driving means from increasing while making the billet loader BL move at the desired speed.

On the other hand, as shown in FIG. 9A, in the fifth embodiment, in the same way as the fourth embodiment (FIG. 8A and FIG. 8B), due to the configuration of the upper second motion conversion mechanism 36, at the billet supply position, the second ball screw shaft 36A of the second motion conversion mechanism 36 projects to the rear from the base 11 (base rear projecting distance L2′). However, this base rear projecting distance L2′ can be sufficiently shortened compared with the base rear projecting distance L2 of the conventional billet supply system 10 (FIG. 3A). For this reason, in the same way as the first embodiment (FIG. 5A to FIG. 5C) and the second embodiment (FIG. 6), in the fifth embodiment as well, this is preferable when there are restrictions on the space for installing the billet supply system in terms of the billet conveyance distance L1 (in particular, the space behind the base).

In the fifth embodiment, the first ball screw shaft 34A of the lower first motion conversion mechanism 34 combined with the first ball nut 34B is fixed to the front of the base 11 to be unable to rotate in the same way as the first embodiment (FIG. 5A to FIG. 5C). As opposed to this, even in the case of another embodiment in which the first ball screw shaft 34A of the lower first motion conversion mechanism 34 is fixed to the rear of the base 11 to be unable to rotate (FIG. 9B), the first ball screw shaft 34A is fixed to be unable to rotate, so like in the modification of the fourth embodiment (FIG. 8B), at the billet supply position, the first ball screw shaft 34A of the first motion conversion mechanism 34 never projects to the rear from the base 11. For this reason, this is suitable for the case where in the fifth embodiment, both when the first ball screw shaft 34A is fixed to the front and to the rear of the base 11 to be unable to rotate, there are restrictions on the space for arrangement of the billet supply system in terms of the billet conveyance distance L1 (in particular, the space at the rear of the base).

Above, the first embodiment to the fifth embodiment and related embodiments are explained for the modes of working the invention, but the present invention is not limited to the above embodiments. It is of course possible to work the invention in various ways within the scope of the content described in the claims.

For example, when explaining the conventional billet supply system for explaining the modes of the billet supply system according to the present invention, the explanation is given predicated on an extrusion press of the back loading type short stroke press system, but there is no problem even if the billet supply system according to the present invention employs not just an extrusion press of a back rotating type short stroke press system, but also the initially explained conventional extrusion press or extrusion press of a front loading type short stroke press system as the billet supply system for conveying a billet from a billet supply position outside of the extrusion press to the position of the extrusion center of the extrusion stem of the extrusion press.

Specifically, in the case of an extrusion press of a back loading type short stroke press system, means (mechanism) are required for making the billet loader made to carry a billet move from the billet supply position to the extrusion center position, then make the billet move on the extrusion center line to make the billet be inserted into the billet holding part of the container, so configuration of a billet loader provided with a billet insertion mechanism, that is, a billet loader system, becomes necessary.

However, in the conventional extrusion press provided with means (mechanism) for making the billet loader made to carry a billet move from the billet supply position to the extrusion center position, then make the billet move on the extrusion center line to insert it into the billet holding part of the container or in an extrusion press of a front loading type short stroke press system, no billet insertion mechanism is required, so a billet loader is also not required. That is, both when the configuration arranged at the extrusion center side end of the second frame is a billet loader not provided with a billet insertion mechanism and a billet loader provided with a billet insertion mechanism, there is no problem in obtaining the effect of the present application.

### REFERENCE SIGNS LIST

1: end platen, 2: cylinder mounting block, 3: tie rod, 4: die, 5: container, 6: extrusion stem, 6a: extrusion stem guide means, 7: main cross head, 8: main hydraulic cylinder, 10: billet supply system, 11: base, 12: main frame, B: billet, C: billet holding part, 30: billet supply system, 32A: first frame, 32B: second frame, 33: linear guide, 33a: rail, 33b: block, 34: first motion conversion mechanism, 34A: first ball screw shaft, 34B: first ball nut, 34C: hollow member, 34D: first rotation support member, 34E: first transmission member (spur gear), 34E′: first transmission member (pulley), 36: second motion conversion mechanism, 36A: second ball screw shaft, 36B: second ball nut, 36D: second rotation support member, 36E: second transmission member (spur gear), 36E′: second transmission member (pulley), 37: common support member, 38: driving means, 38E: third transmission member (spur gear), 38E′: third transmission member (pulley), 38F: pulley belt, BL: billet loader, BS: billet insertion mechanism, L1: billet conveyance distance, L2: base rear projecting distance, L2′: base rear projecting distance, FL1: distance of movement of first frame with respect to base, FL2: distance of movement of second frame with respect to base.

1. A billet supply system having a billet loader carrying a billet in parallel with a billet holding part in a container of an extrusion press and making the billet loader move back and forth between a supply position of the billet and an extrusion center of an extrusion stem of the extrusion press, the billet supply system comprising:
a base arranged separated from the extrusion center to enable placement of the billet on the billet loader at the supply position;
a first frame guided and supported by the base to be able to advance and retract with respect to the extrusion center side;
a first motion conversion mechanism including a first ball screw shaft and a first ball nut screwed with the first ball screw shaft and making the first frame advance and retract with respect to the base;
a second frame guided and supported by the first frame to be able to advance and retract with respect to the extrusion center side and at which the billet loader is arranged at the extrusion center side end;
a second motion conversion mechanism including a second ball screw shaft and a second ball nut screwed with the second ball screw shaft and making the second frame advance and retract with respect to the first frame;
a common support member fixed to the first frame on which either of the first ball screw shaft and the first ball nut and either of the second ball screw shaft and the second ball nut are rotatably supported; and
a driving means for simultaneously driving rotation of either of the first ball screw shaft and the first ball nut and either of the second ball screw shaft and the second ball nut rotatably supported by the common support member through a transmission member,
wherein the other of the first ball screw shaft and the first ball nut is fixed to the base to be unable to rotate,
the other of the second ball screw shaft and the second ball nut is fixed to the second frame to be unable to rotate, and
the driving means being used to make the first frame and the second frame simultaneously advance and retract with respect to the base to and from the extrusion center side.

2. The billet supply system according to claim 1, wherein a first rotation transmission member and a second rotation transmission member are arranged at the rotating end parts of the first motion conversion mechanism and the second motion conversion mechanism at the sides supported rotatably by the common support member, and the first rotation transmission member and the second rotation transmission member are configured to be able to directly transmit rotational motion of one to the other.

3. The billet supply system according to claim 1, wherein
the first ball nut of the first motion conversion mechanism is rotatably supported by the common support member, and
the second ball screw shaft of the second motion conversion mechanism is rotatably supported by the common support member.

4. The billet supply system according to claim 1, further comprising a billet insertion mechanism whereby the billet loader inserts the carried billet in the billet holding part of the container at the extrusion center.
